(19) United States
(12) Patent Application Publication
(10) Pub. No.: US 2018/0253704 A1
(43) Pub. Date: Sep. 6, 2018

(54) Systems and Methods for Use in Facilitating Payment Account Transactions in Connection With Fitness Events

(71) Applicant: MASTERCARD INTERNATIONAL INCORPORATED, Purchase, NY (US)

(72) Inventors: Rick Unnerstall, O'Fallon, MO (US); Cassandra Boland, Chesterfield, MO (US)

(21) Appl. No.: 15/449,068

(22) Filed: Mar. 3, 2017

(51) Int. Cl. G06Q 20/10; G06Q 10/10

(52) U.S. Cl. CPC G06Q 20/102; G06Q 10/1095

(57) ABSTRACT

Systems and methods are provided for use in facilitating payment account transactions in connection with registration of consumers to participate in fitness events. An example method includes generating, at a fitness-pass engine, a fitness-pass profile for a consumer in association with a fitness-pass application, and associating a payment credential for the consumer with the fitness-pass profile. The method also includes, in response to an input from the fitness-pass application, transmitting, by the fitness-pass engine to the fitness-pass application, event content associated with various fitness events based on the input. The method then includes, in response to a selection of one of the fitness events, facilitating a transaction for a fee associated with the selected fitness event between a fitness event organizer for the event and the consumer based on the consumer's payment credential, and transmitting, by the fitness-pass engine, a confirmation of the transaction to the fitness event organizer.

### FIELD

The present disclosure generally relates to systems and methods for use in facilitating payment account transactions in connection with fitness events, and in particular, to systems and methods for use in permitting consumers to pay fees for fitness events and/or otherwise interact with fitness event organizers in connection therewith.

### BACKGROUND

This section provides background information related to the present disclosure which is not necessarily prior art.

Payment accounts are often used by consumers to fund transactions for different types of products (e.g., goods and/or services), including those relating to fitness. Such fitness products may include race events, or more specifically, entry fees for race events (e.g., running events, bicycling events, swimming events, relay races, multi-discipline races (e.g., triathlons, etc.), etc.) etc. In addition, such fitness products may include classes related to race events or to fitness in general, such as spinning classes, aerobic classes, etc. In any case, together, the above may be generally referred to as fitness events. When fitness events are held, participants (broadly, consumers) often have the option to pay for the events through use of cash or check, or through use of payment accounts. Relatedly, various fitness events are known to be associated with websites, such as, for example, websites associated with particular race events (e.g., through www.chicagomarathon.com for the Chicago Marathon, etc.), etc., through which participants are able to learn about the fitness events and often pay fees associated with the fitness events. Other, more generic websites are also available for multiple fitness coordinators (e.g., fitness instructors, personal trainers, small studios, etc.) to schedule fitness events (e.g., classes, etc.) and often further to receive payments for the fitness events (e.g., www.mindbodyonline.com, etc.), etc.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in facilitating payment account transactions in connection with fitness events;

FIG. 2 is a block diagram of an exemplary computing device that may be used in the system of FIG. 1;

FIG. 3 is an exemplary method, which may be implemented in the system of FIG. 1, for use in facilitating a payment account transaction in connection with a consumer registering to participate in a fitness event; and

FIGS. 4-10 illustrate exemplary interfaces that may be displayed to a consumer in connection with the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Participants attend a wide variety of fitness events (e.g., races, fitness classes, etc.) each year. The fitness events are often subject to entry fees or registration fees (broadly, fees), which are paid by the participants in order to take part in the events. Typically, the fees may be paid through cash or check, or through use of payment accounts, at the sites of the fitness events (e.g., via point-of-sale terminals associated with the fitness events, etc.) or in advance through one or more websites associated with the fitness events.

Uniquely, the systems and methods herein permit participants to select and pay for one or more different fitness events through a fitness-pass engine associated with the one or more fitness events. In particular, the fitness-pass engine permits fitness event organizers to register their fitness events, and thereupon disseminate the fitness events to a companion fitness application active on communication devices associated with consumers (i.e., potential participants). The companion fitness application, in turn, permits the consumers to search for and register for the different registered fitness events (or further to detect fitness events by location or by geo-fences associated with the fitness events). The companion fitness application may further permit the consumers to pay fees associated with the fitness events, to register for the events, and to perform other related actions (e.g., execute waivers or other forms associated with the fitness events, view results, etc.). Further, once fees are paid by a consumer for a fitness event, and the consumer is registered for the event, the fitness event organizer is notified of the consumer's payment, and the consumer is then notified (e.g., via the fitness application, etc.) of information related to the fitness event (e.g., packet pickup time/location, participant confirmation code, fitness event time/location, etc.). Then, as the fitness event approaches, the companion fitness application may allow the registered consumer to check-in for the fitness event. In this manner, through use of the fitness application and engine, consumers are able to efficiently identify and register for different fitness events, manage different fitness events for which they are registered (even those offered by different event organizers), conveniently pay any necessary fees associated with the events, and further check-in for desired fitness events as they commence. Similarly, through use of the fitness-pass engine, organizers are able to publish and provide access to various fitness events to consumers (as potential participants), receive payment of fees relating to the fitness events, and further facilitate communication with the consumers once registered to provide efficient access to the various events.

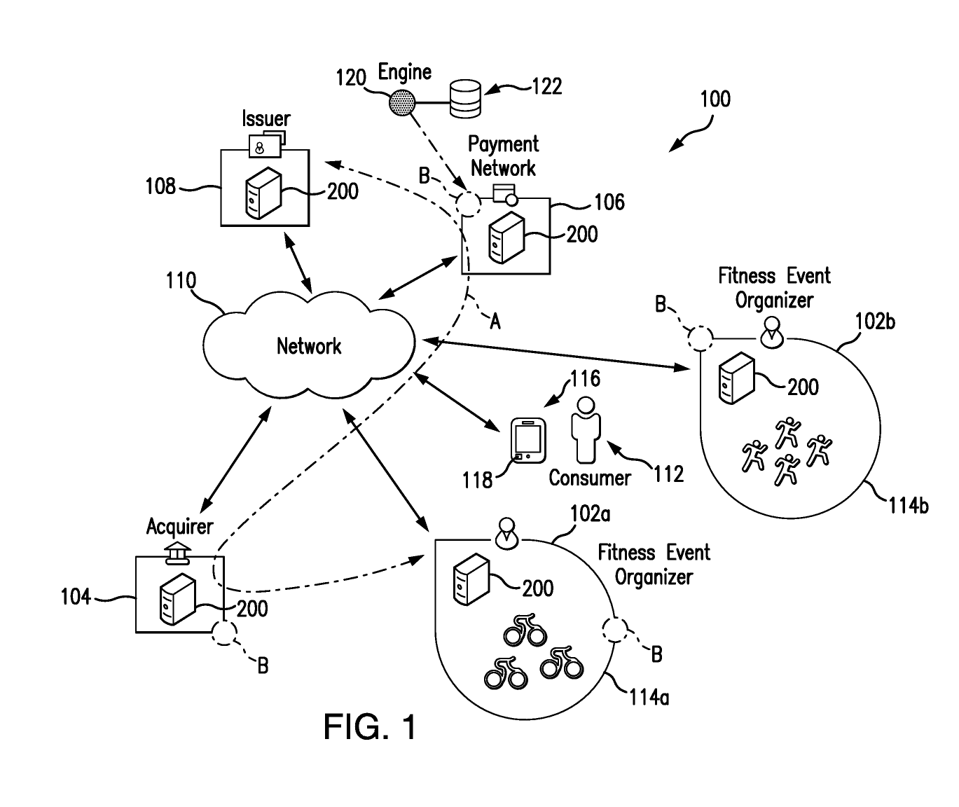

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise depending on, for example, processing of payment account transactions, relatedness of fitness events included therein, registration of/for different fitness events, etc.

As shown in FIG. 1, the exemplary system 100 generally includes two fitness event organizers 102a-b (i.e., fitness merchants), which are each associated with at least one fitness event available to various participants, an acquirer 104 associated with each of the fitness event organizers 102a-b, a payment network 106, and an issuer 108, each coupled to (and in communication with) network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In particular in this example, the acquirer 104, the payment network 106, and the issuer 108 may be connected via a private payment transaction network that is part of network 110 for processing payment account transactions, and separately the fitness event organizers 102a-b may be connected with the acquirer 104 and various participants (e.g., consumer 112, etc.), for example, through a public network, such as the Internet, that is also part of network 110.

In the system 100, the fitness event organizers 102a-b are generally understood to offer fitness events for sale to participants, including the consumer 112. The fitness events may include, for example, running races (e.g., 5 K's, 10 K's, half marathons, marathons, etc.), bicycle races, swimming races, triathlons, etc. Additionally, the fitness events may include fitness classes, sessions and/or appointments, such as, for example, those involving yoga, Pilates, boot camps, boxing, personal training, weight training, spinning, kickboxing, aerobics, personal training, etc., and may further include team sports such as soccer (e.g., where players may be required to register/pay in order to play as they show up for matches, etc.), tennis, racquetball, etc. More generally, the fitness events may be understood to include any events in which participants take part in physical activities and/or competitions, and/or achieve, gain, or demonstrate fitness, etc. at any level and in any groupings and/or arrangement of participants. In this exemplary embodiment, the fitness event organizer 102a is associated with a bicycle race, while the fitness event organizer 102b is associated with a run (e.g., a 5 K/10 K race, etc.). With that said, it should be appreciated that any number and/or type of event organizers, and any number and/or type of fitness events, may be included in systems in other embodiments, and that the specific types (e.g., fitness types, other types, etc.) and/or the specific number (e.g., two, more than two, less than two, etc.) of fitness events and/or event organizers is not limited by the exemplary system 100.

Further, the fitness event associated with fitness event organizer 102a is associated with a location identified by boundary 114a, and the fitness event associated with fitness event organizer 102b is associated with a location identified by boundary 114b. The boundaries 114a-b may be specific to the fitness events, or may be more general to an area associated with locations of the fitness events. For example, the boundaries 114a-b may define specific locations (e.g., addresses, latitudes/longitudes, etc.), or more general regions (e.g., postal codes, area codes, geo-fences, parks, trails, etc.), etc. In any case, it should be appreciated that the fitness event organizers 102a-b are not limited to the boundaries 114a-b, as the organizers 102a-b and/or the associated fitness events may be inside and/or outside of the boundaries 114a-b in various different embodiments.

Also in the system 100, the consumer 112 may be considered a participant (or potential participant) in one or more of the various described fitness events offered/provided by the fitness event organizers 102a-b. In connection therewith, the consumer 112 is associated with a payment account, which is issued by the issuer 108 and which may be used by the consumer 112 to pay fees to the event organizers 102a-b for taking part in the fitness events (and to perform purchase transactions with other merchants). Further, the consumer 112 is associated with a communication device 116. The communication device 116 may include, for example, any suitable communication device such as a smartphone, a tablet, etc. In the illustrated embodiment, the communication device 116 includes a network-based application 118, referred to herein as a fitness-pass application, which is installed and active in the communication device 116 for use by the consumer 112 to interact with, for example, the event organizers 102a-b or a fitness-pass engine 120 in connection with their various fitness events (e.g., to register for the fitness events, etc.). This will be described in more detail below. In some embodiments, the fitness-pass application 118 is a standalone application, while in other embodiments the fitness-pass application 118 may be associated and/or integrated with a virtual wallet application, for use in facilitating payments for fitness events.

In an exemplary transaction in the system 100, the consumer 112 may seek to pay fees to the fitness event organizer 102a, in order to take part in the bicycle race. As such, the consumer 112 presents a payment device (e.g., a credit card, a debit card, a prepaid card, a fob, the communication device 116 with a virtual wallet application active, etc.) to the fitness event organizer 102a (e.g., via a website associated with the fitness event organizer 102a, in person at the fitness event organizer 102a, etc.), or otherwise directs the fitness event organizer 102a to his/her account (e.g., by providing credentials for the account to the fitness event organizer 102a, etc.). The fitness event organizer 102a receives and/or retrieves the credentials for the consumer's payment account and, as is traditional, communicates an authorization request for the transaction (comprising transaction data for the transaction) along path A in FIG. 1 to the acquirer 104 (through the network 110). In turn, the acquirer 104 communicates the authorization request with the issuer 108 (associated with the consumer's payment account) (again via the network 110) along path A through the payment network 106 (e.g., through MasterCard®, VISA®, Discover®, American Express®, etc.). The issuer 108 determines whether the consumer's payment account is in good standing and whether there are sufficient funds and/or credit to fund the transaction. If approved, an authorization reply, or response (indicating the approval of the transaction), is transmitted back from the issuer 108 to the fitness event organizer 102a along path A, thereby permitting the fitness event organizer 102a to complete the transaction. The transaction is later cleared and/or settled (via appropriate transaction messages such as clearing messages and/or settlement messages, for example) by and between the fitness event organizer 102a, the acquirer 104, and the issuer 108 (by appropriate agreements). If the transaction is declined, however, an authorization reply (indicating the decline of the transaction) is provided back to the fitness event organizer 102a, thereby permitting the fitness event organizer 102a to halt or terminate the transaction, or request alternate funding.

While the above exemplary transaction is described with reference to the fitness event organizer 102a, it should be appreciated that transactions between the consumer 112 and the fitness event organizer 102b, and funded by the payment account associated with the consumer 112 (or other payment accounts), will be substantially consistent therewith.

Transaction data is generated (and included in transaction messages), collected, and stored as part of the above interactions among the fitness event organizer 102a (and for similar transactions involving the other fitness event organizer 102b), the acquirer 104, the payment network 106, the issuer 108, and the consumer 112. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the acquirer 104 and/or the issuer 108 may store the transaction data, or part thereof, in a data structure. With that said, transaction data may include, for example, payment account numbers (e.g., primary account numbers (PANs), etc.), amounts of transactions, card verification codes (CVCs), expiration dates, merchant IDs, terminal IDs, merchant category codes (MCCs), merchant names, dates/times of transactions, products purchased and related descriptions or identifiers, etc. Further, when the transactions involve virtual wallet applications and/or are facilitated through other applications (e.g., application 118, etc.), application IDs may be included in the transaction data particular to the applications. It should be appreciated that more or less information related to transactions, as part of either authorization and/or clearing and/or settling, may be included in transaction data and stored within the system 100.

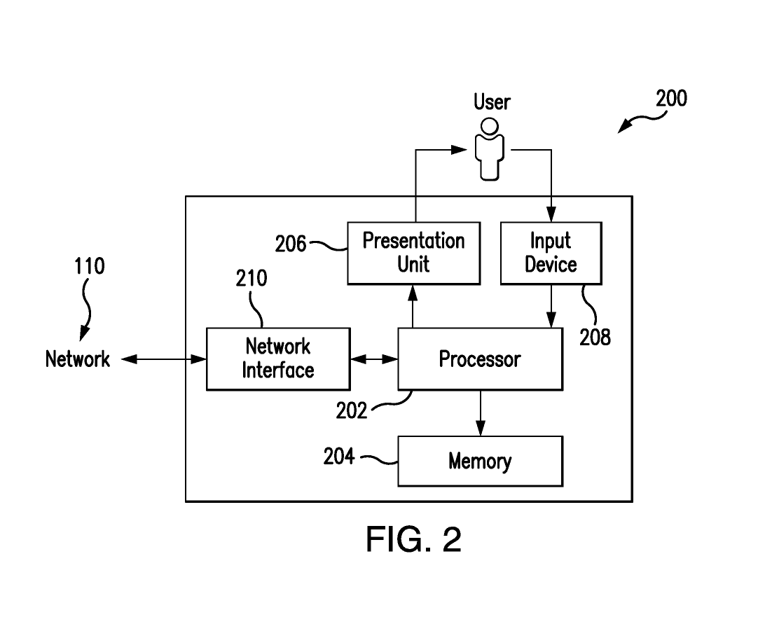

FIG. 2 illustrates an exemplary computing device 200 that can be used in the system 100. The computing device 200 may include, for example, one or more servers, workstations, personal computers, laptops, tablets, smartphones, POS terminals, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In the system 100, each of the fitness event organizers 102a-b, the acquirer 104, the payment network 106, and the issuer 108 are illustrated as including, or being implemented in, computing device 200, coupled to (and in communication with) the network 110. In addition, the communication device 116 associated with the consumer 112 and the engine 120 may each be considered a computing device consistent with the computing device 200. However, the system 100 should not be considered to be limited to the computing device 200, as described below, as different computing devices and/or arrangements of computing devices may be used.

Referring to FIG. 2, the exemplary computing device 200 generally includes a processor 202 and a memory 204 coupled to (and in communication with) the processor 202. The processor 202 may include one or more processing units (e.g., in a multi-core configuration, etc.) including, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, transaction data, fitness-pass profiles, event content, event confirmation codes, and/or other types of data and/or information suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 (or output device or display device) that is coupled to (and is in communication with) the processor 202 (however, it should be appreciated that the computing device 200 could include output devices other than the presentation unit 206, etc.). The presentation unit 206 outputs information, either visually or audibly to a user of the computing device 200, for example, to the consumer 112 (e.g., event content for fitness events, etc.) and/or to the fitness event organizers 102a-b (e.g., confirmation codes for participants of fitness events, etc.), etc. It should also be appreciated that various interfaces may be displayed at computing device 200, and in particular at the presentation unit 206, to display such information, for example, event content, confirmation codes, information relating to fitness-pass profiles, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 further includes an input device 208 that receives inputs from the user of the computing device 200 (i.e., user inputs), including, for example, selections of fitness events, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit 206 and an input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. In one embodiment, the network interface 210 includes a transmitter/transceiver interface (e.g., via RF, RFID, NFC, Bluetooth, ZigBee, etc.) (e.g., iBeacon, etc.), which transmits a signal indicative of the fitness event, thereby defining the boundary of the fitness event (e.g., boundaries 114a-b, etc.), etc., and capable of being received by another computing device (e.g., communication device 116, etc.). The network interface 210 may further include a positioning interface (e.g., GPS antenna/receiver, etc.) configured to determine the location of the computing device 200, through interactions with satellites and/or other source signal generators, etc. Further, in some exemplary embodiments, the computing device 200 includes the processor 202 and one or more network interfaces incorporated into or with the processor 202.

With reference again to FIG. 1, the system 100 includes the fitness-pass engine 120 and a data structure 122 configured, often by computer-executable code, to perform as described herein. The fitness-pass engine 120 is illustrated as a standalone device and, for example, as indicated above is consistent with computing device 200, etc. Nonetheless, as indicated by the dotted lines, and further by the various dotted designations B, the fitness-pass engine 120 (and/or the data structure 122) may be incorporated (in whole or in part) into one or more of the fitness event organizers 102a-b, the acquirer 104, and the payment network 106 (e.g., as part of the corresponding computing device 200 therein, etc.), or further, into other parts of the system 100 illustrated, or not, in FIG. 1.

The data structure 122 is illustrated as coupled to the fitness-pass engine 120 and is accessible by the fitness-pass engine 120 as described herein. In connection therewith, the data structure 122 may be incorporated in and/or stored in memory 204 associated with the fitness-pass engine 120, or may alternatively (or additionally (at least in part)) be incorporated in and/or stored in memory 204 of another computing device 200. In addition, the data structure 122 is illustrated as a single data structure. However, it should be appreciated that the data structure 122 may include one or multiple different data structures within the scope of the present disclosure.

In the illustrated system 100, the data structure 122 includes a fitness event data structure, comprising a listing of fitness events registered through the fitness-pass engine 120 (as will be described more hereinafter) and event content associated with each. In connection with such listing, the event content for the various registered fitness events may include times of the events, places/locations of the events, descriptions of the events, fees associated with the events (e.g., entry fees, etc.), etc. With that said, Table 1 illustrates exemplary event content that may be included in the data structure 122 (in the fitness event data structure thereof) for four different example fitness events, as provided by different fitness event organizers (e.g., the Ride Ramble may be associated with the fitness event organizer 102a, and the Mad Dash and the Long Dash may be associated with the fitness event organizer 102b, and; etc.). It should be appreciated that, in other embodiments, additional, different or other event content may be included in the data structure 122 for one or more of the different fitness events, or for different fitness events (e.g., waiver forms, instructions for pickup of various packets relating to the fitness events, requirements for participating in the fitness events, event type indicators, maximum numbers of participants, age categories for participants, start and stop times, durations, GPS related data for use in identifying geo-fence zones for the events, etc.). In addition, it should be appreciated that the data structure 122 may include event content for any desired number of fitness events (e.g., for any desired number of events including four events as illustrated in Table 1, less than four events, more than four events, etc.).

TABLE 1

| Event | Event | Event | Start | Event | | Entry | Maximum |
|---|---|---|---|---|---|---|---|
| Name | Organizer | Description | Time | Date | Location | Fee | Participants |
| Mad | 102b | 5K/10K | 8:00 am | June 16 | City Park | $15/$20 | 2,000/1,000 |
| Dash | | | | | | | |
| Long | 102b | Half | 7:30 am | June 16 | City Park | $45.00 | 1,000 |
| Dash | | marathon | | | | | |
| Bending | Yoga | Yoga Class | 3:30 pm | M-W-F | Studio | $18.50 | 20 |
| Yoga | Studio | | | | | | |
| Ride | 102a | 50 mile | 8:00 am | June 25 | Track | $72.00 | 500 |
| Ramble | | bicycle race | | | | | |

Generally, the data structure 122 (specifically, the fitness event data structure thereof) is populated with fitness events through registration of the fitness events with the fitness-pass engine 120, by the fitness event organizers 102a-b (and by other fitness event organizers). Upon registration of a fitness event with the fitness-pass engine 120, the fitness-pass engine 120 is configured to store event data for the registered fitness event in the data structure 122. The fitness events may be organized in the data structure 122 as desired (e.g., by location, by event type, by organizer, by name, etc.).

To facilitate such registration, in this exemplary embodiment, the fitness-pass engine 120 is configured to expose a network-based interface (e.g., a website, an application, an application programming interface (API), etc.), for display at presentation unit 206 (associated with a corresponding computing device 200 of the fitness event organizers 102a-b), through which the fitness event organizers 102a-b are permitted to submit their fitness events for registration. Through the interface (or through multiple such interfaces), the fitness-pass engine 120 may be configured to solicit certain event content from the fitness event organizers 102a-b for the fitness events to be registered. Such event content, for example, may be consistent with the event content illustrated in Table 1. In addition, the solicited event content may include waiver forms to be executed by participants (e.g., by the consumer 112, etc.) of the fitness events, instructions for pickup of various packets relating to the fitness events, requirements for participating in the fitness events, or any other content which may be used (or required to be used) by the fitness-pass engine 120 and/or the fitness event organizers 102a-b for participants to subsequently register for the given fitness event, etc. (broadly, event content). Further, the solicited event content may include payment account information associated with the fitness event organizers 102a-b (e.g., for use in routing payments received from participants to appropriate ones of the organizers 102a-b, etc.), fitness related loyalty information and/or incentives potentially offered by the fitness event organizers 102a-b to participants of their events, etc. Moreover, in certain embodiments, the fitness-pass engine 120 may be used as a gateway to aggregate photos of participants at the given events, for subsequent access by the participants (and, potentially, others with appropriate access).

Also in the illustrated system 100, the data structure 122 includes a fitness-pass profile data structure, including multiple fitness-pass profiles specific to different event participants (e.g., consumer 112, etc.). The fitness-pass profiles are generated and/or stored in the data structure 122 through one or more interactions between the fitness-pass application 118 and the fitness-pass engine 120, as described below. In connection therewith, each of the fitness-pass profiles in the data structure 122 (specifically, in the fitness-pass profile data structure thereof) may include, for example, contact information for the participant, fitness event histories (e.g., event attendance, event times, finish positions/ranks, photographs, other participation information, etc.), payment account information, payment account credentials, event confirmation codes, event registration information, calendars of fitness events, etc.

With continued reference to FIG. 1, the fitness-pass application 118 in the system 100 is configured to be appended to the consumer's communication device 116 (e.g., downloaded, etc.) and activated thereon as desired. Then, once active, the fitness-pass application 118 is configured to facilitate registration of the consumer 112, in cooperation with the fitness-pass engine 120, so that the consumer 112 can select desired ones of the fitness events stored in the data structure 122 in which to participate. Specifically, for example, the fitness-pass application 118 is configured to display multiple interfaces to the consumer 112, at the communication device 116 (via the fitness-pass application 118), for example, to solicit information needed to initially register the consumer 112 to the fitness-pass engine 120. In response, the consumer 112 provides the solicited information, or part thereof, and provides an input to register to the fitness-pass application 118 and/or the fitness-pass engine 120. In turn, the fitness-pass engine 120 compiles the information into a fitness-pass profile for the consumer 112 and stores the profile in the data structure 122 (specifically, in the fitness-pass data structure thereof) as described above.

In connection with registering the consumer 112 to the fitness-pass engine 120, the fitness-pass application 118 (and/or the fitness-pass engine 120) is configured to associate payment credentials associated with the consumer's payment account to the fitness-pass profile for the consumer 112 and/or the fitness-pass application 118 at the consumer's communication device 116. In one example, the fitness-pass engine 120 (via the fitness-pass application 118) is configured to solicit payment account information from the consumer 112 as part of his/her registration to the fitness-pass engine 120, whereupon payment credentials for the consumer's payment account (e.g., a PAN, an expiration date, a CVC, a token, etc.) are stored in the data structure 122 as part of the consumer's fitness-pass profile (for retrieval by the fitness-pass engine 120 as necessary). In another embodiment, the fitness-pass engine 120 is configured to provision payment credentials (e.g., a payment token, etc.) associated with the consumer's payment account to the fitness-pass application 118 (or to a virtual wallet application associated therewith), whereupon the fitness-pass application 118 itself becomes a payment device, via the communication device 116. In still another embodiment, the fitness-pass application 118 operates as a virtual wallet application (either directly, or in conjunction with such a virtual wallet application at the consumer's communication device 116) whereby the application 118 includes (or has access to) one or more payment credentials (e.g., a payment card associated with the consumer's payment account, a token therefor, etc.) pre-approved by the consumer 112 for use with the application 118, and acceptable by the fitness-pass engine 120 for use as described herein. In this example, the consumer 112, then, is able to add/change/delete payment credentials associated with the application 118 as desired.

In various embodiments, registering the consumer 112 to the fitness-pass engine 120 may further include selection and/or issuance of log-in credentials to the consumer 112 by the fitness-pass engine 120 (broadly, authentication credentials which may, in some embodiments, include biometric authentication credentials (e.g., by the consumer 112 providing a reference biometric, etc.), etc.). In particular, the fitness-pass engine 120 may be configured to solicit login credentials from the consumer during registration, which are then required for the consumer 112 to subsequently access the fitness-pass application 118 at the communication device 116 and/or the consumer's fitness-pass profile (e.g., via another computing device, etc.). In at least one embodiment, however, login credentials for the fitness-pass application 118 are omitted, thereby relying on other authentication of the consumer 112 associated with the communication device 116 (e.g., screen password, etc.), if any.

It should be appreciated that registration of the consumer 112 in the system 100 (and of other consumers) includes various interactions between the consumer 112 and the fitness-pass engine 120, via the fitness-pass application 118. In at least one other embodiment, however, the fitness-pass engine 120 may be associated with a website, through which the consumer 112 is able to interact with the fitness-pass engine 120 as described herein, via the communication device 116 or another computing device, without use of the fitness-pass application 118. In addition, in one or more embodiments, the fitness-pass application 118 may also be configured, for use by one of the fitness-event organizers 102a-b, to facilitate registration and/or management of fitness events (such that the organizers 102a-b may utilize both functionalities of the fitness-pass application 118).

Once the consumer 112 is registered, and logged in to the fitness-pass application 118, as needed, the fitness-pass application 118 is configured to solicit fitness events from the fitness-pass engine 120. For example, the fitness-pass application 118 is configured to display multiple interfaces to the consumer 112, which permit the consumer to provide input(s) indicative of desired fitness events in which to participate (or to retrieve in general), such as, for example, a desired city, state, postal code, distance, event type, age range, event type (e.g., team sport events, etc.), time/date, awards (Y/N), etc. In turn, the fitness-pass application 118 is configured to transmit the input(s) to the fitness-pass engine 120, for identification of one or more desired fitness events (in the data structure 122) that satisfy the input(s) (as described more hereinafter). As another example, the boundary 114a associated with the fitness event organizer 102a may be defined by a geo-fence, such that when the fitness-pass application 118 enters the geo-fence (or other boundary 114b), the fitness-pass application 18 is configured to identify the fitness event from the geo-fence boundary, for example, and to transmit an input to the fitness-pass engine 120 indicative of the geo-fence and/or fitness event (e.g., a fitness event ID emitted by the computing device 200 of the fitness event organizer 102a, etc.). In addition, or alternatively, in still another example the fitness-pass application 118 may be configured to transmit a location of the communication device 116 as an input to the fitness-pass engine 120 (e.g., as identified by use of a GPS interface (as network interface 210) of the communication device 116, etc.).

In turn in the system 100, the fitness-pass engine 120 is configured to receive the input(s) from the consumer 112, via the fitness-pass application 118 (regardless of type), and search in the data structure 122 for fitness events consistent with the input(s). The fitness-pass engine 120 is then configured to return event content to the fitness-pass application 118 for fitness events (if any) consistent with the received input(s), for display to the consumer 112 (e.g., at presentation unit 206, etc.). The event content may include all available event content for the identified fitness events included in the data structure 122, or a portion thereof (e.g., such as shown in Table 1, etc.). In response, the fitness-pass application 118 is configured to display the identified event content to the consumer 112 (thereby allowing the consumer 112 to view the same) and to receive a selection from the consumer 112 of one or more of the associated fitness events. When a fitness event is selected by the consumer 112, the fitness-pass application 118 is configured to return the selection to the fitness-pass engine 120, which may then be configured to transmit more event content (e.g., a liability waiver, etc.) to the fitness-pass application 118 for review and/or further action by the consumer 112.

Then, when the consumer 112 decides to register for a fitness event displayed at the fitness-pass application 118 (and provided by the fitness event organizer 102a, for example), the consumer 112 selects the fitness event and, in response, the fitness-pass application 118 is configured to provide a registration interface (or multiple such interfaces) to the consumer 112. The registration interface may solicit a variety of information from the consumer 112 and/or it may be pre-populated, by the fitness-pass application 118 and/or fitness-pass engine 120, with information from the consumer's fitness-pass profile (as stored in the data structure 122). In various embodiments, a substantial portion of the information in the registration interface will be pre-populated with information from the consumer's fitness-pass profile, and then will further include a waiver section that may be electronically signed and/or otherwise acknowledged or agreed to by the consumer 112 in connection with the fitness event (e.g., as required by the fitness event organizer 102a associated with the fitness event, etc.).

Once the registration interface is completed, the fitness-pass application 118 is configured to submit the registration interface and/or the inputs thereto to the fitness-pass engine 120. In response, the fitness-pass engine 120 is configured to confirm that the submitted registration information is complete, and to facilitate a payment account transaction for any fees associated with the fitness event (consistent with the exemplary transaction described above). In one example, the fitness-pass engine 120 is configured to retrieve and utilize payment credentials included in the consumer's fitness-pass profile (in the data structure 122) to facilitate the payment account transaction. While in another example, the fitness-pass application 118 is configured to transmit a payment token for the consumer's payment account to the fitness-pass engine 120 along with the registration inputs for the fitness event, and the fitness-pass engine 120 is then configured to rely on the payment token to facilitate the payment account transaction.

In any case, once the payment account transaction is authorized (as described above), the fitness-pass application 118 and/or the fitness-pass engine 120 are configured to register the consumer 112 for the fitness event. In connection therewith, the fitness-pass application 118 is configured to identify the fitness event in the consumer's fitness-pass profile and, potentially, update a participant list for the fitness event at the data structure 122 (e.g., in the fitness event data structure thereof, etc.). In addition, the fitness-pass engine 120 may be configured to transmit a registration notification to the consumer 112 (e.g., via the fitness-pass application 118, via email, via SMS, etc.), confirming the registration and providing an event confirmation code (which may also be stored in association with the consumer's fitness-pass profile in the data structure 122). Further, the fitness-pass engine 120 may also be configured to notify the fitness event organizer 102a of the consumer 112 and/or the consumer's event confirmation code associated with the event registration. In so doing, the fitness-pass engine 120 may be configured to transmit the notification to the fitness event organizer 102a (e.g., via email, via SMS, etc.). Or, alternatively, the fitness-pass engine 120 may be configured to simply store the event confirmation code and/or a consumer identifier for the consumer 112 in the data structure 122 (such that it is then accessible to the fitness event organizer 102a). For example, the fitness event organizer 102a may utilize the fitness-pass engine 120 to manage registration for all participants for the fitness event, whereby the fitness-pass engine 120 would be able to maintain a listing of all registered participants on behalf of the fitness event organizer 102a, maintain a revenue total in real time, etc.

Finally, as the fitness event approaches, the fitness-pass application 118 may also be configured to allow the registered consumer 112 to check-in for the fitness event. For example, the fitness-pass application 118 may be configured to detect a geo-fence associated with the fitness event, and in particular a boundary defined by such geo-fence. The boundary may be defined by a wireless signal (e.g., from i-Beacons, RFID transmitters, etc.) indicative of fitness event. Upon detection of the particular wireless signal, the fitness-pass application 118 may be configured to confirm with the fitness-pass engine 120 that the consumer 112 is present at the fitness event and thereby check the consumer 112 in for the fitness event (and potentially then provide instructions to the consumer 112, via the fitness-pass application 118, for proceeding to a start or other participant queuing location for the fitness event).

With that said, it should be appreciated that while certain operations and/or configurations are described above with reference to the fitness-pass engine 120, they may also be performed by the fitness-pass application 118, and vice-versa, within the scope of the present disclosure. It should also be appreciated that in addition to, or alternatively to, the above, the fitness-pass application 118, the fitness-pass engine 120, and/or the data structure 122 may be configured otherwise to perform any of the operations described herein.

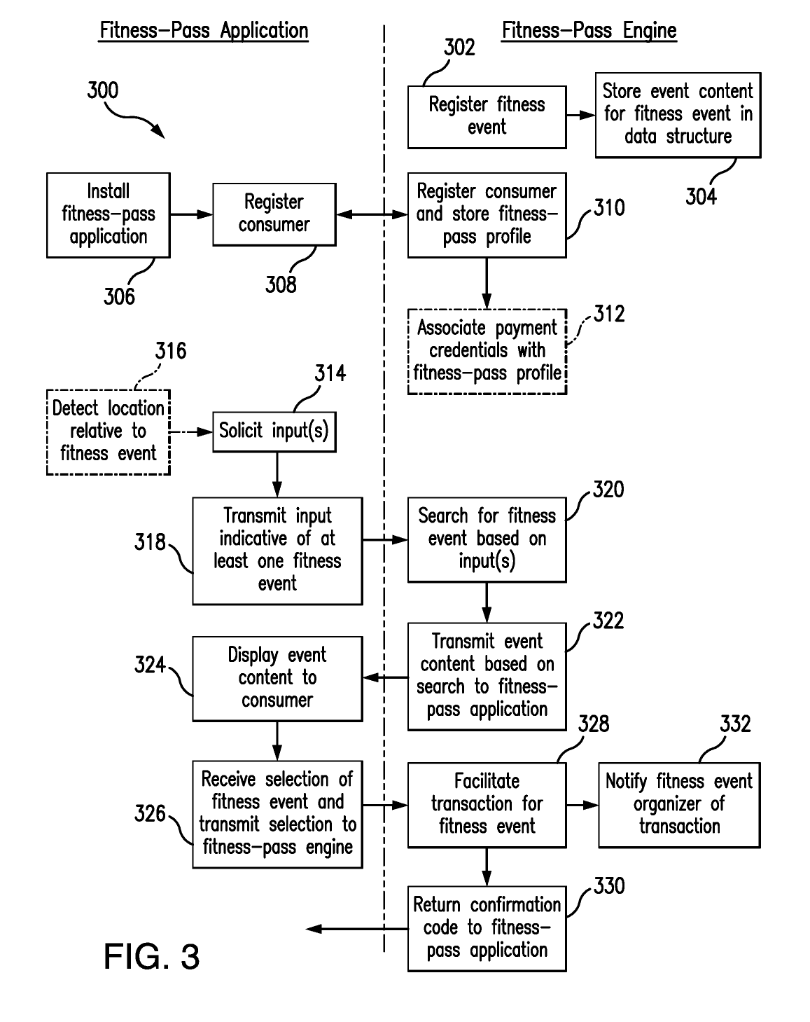

FIG. 3 illustrates an exemplary method 300 for use in facilitating a payment account transaction, on behalf of a consumer, in connection with the consumer registering to participate in a fitness event. The exemplary method 300 is described as implemented in the system 100 and, more particularly, in the fitness-pass application 118 and the fitness-pass engine 120 thereof. In addition, the method 300 is described with reference to the computing device 200. Nonetheless, as should be understood, the methods herein (including the method 300) are not limited to the exemplary system 100 or the exemplary computing device 200 and, similarly, the systems and the computing devices herein are not limited to the exemplary method 300.

Initially in the method 300, the fitness-pass engine 120 registers the bicycle race (broadly, the fitness event) associated with the fitness event organizer 102a, at 302. In so doing, the fitness-pass engine 120 solicits and receives (e.g., via a network-based interface, etc.) various event content from the fitness event organizer 102a for the bicycle race (e.g., event name, event description, event time, event date, event location, entry fee, etc.). The fitness-pass engine 120 then stores the received event content in the data structure 122, at 304, in association with the fitness event. It should be appreciated that the fitness-pass engine 120 may similarly register the race associated with the fitness event organizer 102b (as well as fitness events associated with other organizers).

Separately in the method 300, the consumer 112 installs the fitness-pass application 118 at his/her communication device 116, at 306. Then, once active, the fitness-pass application 118 begins to register the consumer 112, at 308, which in turn causes the consumer 112 to be registered at the fitness-pass engine 120 (e.g., via various interfaces, etc.), at 310. The interactions between the consumer 112, the fitness-pass application 118, and the fitness-pass engine 120 may include the passing of a variety of data, including, for example, the consumer's name, contact information, demographic information, user name, password, payment account information, etc. In particular, the fitness-pass application 118 solicits information from the consumer 112 through one or more interfaces at the communication device 116. The fitness-pass application 118 then transmits the information to the fitness-pass engine 120, which, in turn, as part of registering the consumer 112 and/or the fitness-pass application 118, compiles the information into a fitness-pass profile for the consumer 112 and stores the profile in the data structure 122, at 310.

Generally, payment credentials for the consumer 112 will be stored at the fitness-pass application 118, at the consumer's communication device 116. For example, the fitness-pass application 118 may operate as a virtual wallet application (either directly, or in conjunction with such a virtual wallet application at the consumer's communication device 116), whereby the application 118 includes (or has access to) one or more payment credentials for the consumer 112, pre-approved by the consumer 112 for use with the application 118, and acceptable by the fitness-pass engine 120 for use as described herein. Alternatively (or additionally), however, as indicated by the dotted lines in FIG. 3, in connection with registering the consumer 112, at 308 and 310, the fitness-pass engine 120 may further associate, at 312, one or more payment credentials for the consumer's payment account with the fitness-pass profile for the consumer 112. In particular, the fitness-pass application 118 and/or the fitness-pass engine 120 may solicit payment account information from the consumer 112 as part of his/her registration (at 308 and/or 310). Then, upon receipt of payment credentials for the payment account, the fitness-pass engine 120 may store the payment credentials for the consumer's payment account (e.g., a PAN, an expiration date, a CVC, etc.) in the data structure 122 as part of the consumer's fitness-pass profile.

With continued reference to FIG. 3, once the consumer 112 is registered, from time to time, the consumer 112 may desire to utilize the fitness-pass application 118. In doing so, the consumer 112 enters the fitness-pass application 118 at the communication device 116, whereupon the fitness-pass application 118 solicits one or more inputs from the consumer 112 (and/or from the consumer's communication device 116), at 314, regarding potential fitness events in which the consumer 112 may wish to participate. For example, the fitness-pass application 118 may solicit a particular input indicative of the bicycle race provided by the fitness event organizer 102a (e.g., a desired city, state, postal code, distance, event type, event name, etc.). Or, optionally (as indicated by the dotted lines in FIG. 3), the fitness-pass application 118 may detect a boundary and/or location of the communication device 116, at 316, and identify the boundary and/or location as the input. In one example, as described above, the fitness-pass application 118 may detect a geo-fence associated with the bicycle race, and in particular, the boundary 114a. The boundary 114a may be defined by a wireless signal (e.g., from i-Beacons, RFID transmitters, etc.) indicative of the bicycle race (e.g., indicative of a fitness event ID for the bicycle race, etc.) (broadly, an input). It should be appreciated that a variety of manners may exist for providing an input indicative of a fitness event, or multiple fitness events, to the fitness-pass application 118.

Regardless of the source and/or type of the input(s), once the input(s) is/are received, the fitness-pass application 118 transmits the input(s), at 318, to the fitness-pass engine 120.

In turn, the fitness-pass engine 120 receives the input(s) from the fitness-pass application 118 and searches, at 320, in the data structure 122 for the bicycle race, consistent with the input(s). The search may include a key word search based on the input(s) (e.g., based on a name of the bicycle race, etc.), or it may include a location search based on the input(s) (e.g., based on the consumer's communicator device 116 being within a geo-fence associated with the bicycle race, etc.). In any case, once the search is complete, the fitness-pass engine 120 transmits event content for the bicycle race (and for any other fitness event(s) consistent with the input(s)) to the fitness-pass application 118, at 322. And, the fitness-pass application 118 displays the event content to the consumer, at 324 (via presentation unit 206, etc.).

Upon display of the event content for the bicycle race to the consumer 112, by the fitness-pass application 118, at 324, when the consumer 112 decides to register for the bicycle race, the fitness-pass application 118 receives a selection from the consumer 112 of the bicycle race, at 326, and transmits the selection to the fitness-pass engine 120. In addition, in connection with receiving the selection of the bicycle race, the fitness-pass application 118 may also register the consumer 112 for the race (e.g., via a registration interface, etc.). In so doing, the fitness-pass application 118 may collect necessary information from the consumer 112 and transmit such information to the fitness-pass engine 120 along with the event selection, at 326. Alternatively, or additionally, the fitness-pass engine 120 may retrieve necessary information for the consumer 112, to facilitate the registration, from the data structure 122 (specifically, from the consumer's fitness-pass profile). In particular, for example, the fitness-pass engine 120 may return terms consistent with a waiver of liability to the fitness-pass application 118, which require the consumer's signature and/or acknowledgement in order for registration to proceed.

Once the event registration of the consumer 112 is complete (and all necessary and/or desired information is received from the fitness-pass application 118), the fitness-pass engine 120 facilitates a payment account transaction, at 328, for any fees associated with the bicycle race (consistent with the exemplary transaction described above in the system 100). In particular in the method 300, the fitness-pass engine 120 is configured to retrieve and utilize payment credentials from the fitness-pass application 118 to facilitate the payment account transaction. Alternatively, the fitness-pass engine 120 may retrieve and utilize payment credentials included in the consumer's fitness-pass profile (in the data structure 122). Regardless, in turn, the fitness-pass engine 120 may submit a transaction to the acquirer 104 and/or the payment network 106, which involves the payment of funds from the consumer's payment account to an account associated with the fitness event organizer 102a. It should be appreciated that the particular transaction and/or initiation of the transaction may be specific to the implementation of the fitness-pass engine 120 (e.g., as part of the payment network 106, at the fitness event organizer 102a, etc.).

When the payment account transaction is authorized (again as described above), the fitness-pass engine 120 transmits a registration notification to the consumer 112 (via the fitness-pass application 118), at 330, confirming the registration for the bicycle race and providing an event confirmation code therefore. In addition, the fitness-pass engine 120 transmits a notification to the fitness event organizer 102a, at 332, indicating that the consumer 112 has registered for the bicycle race and that a transaction for the associated entry fee has been performed.

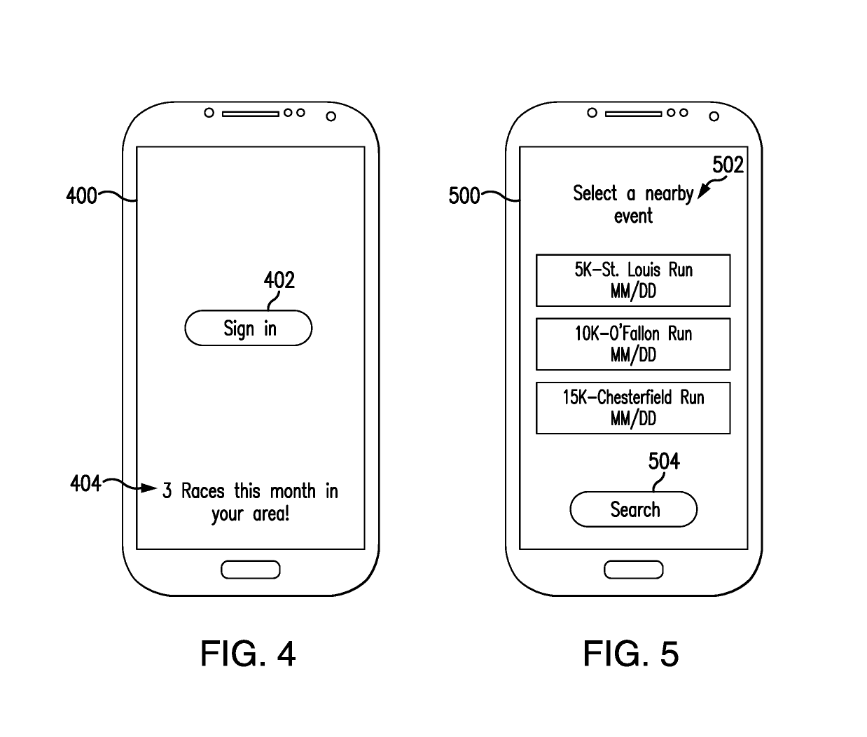

FIGS. 4-10 illustrate a series of exemplary interfaces that may be displayed to the consumer 112 in connection with the method 300, for example, when the consumer 112 searches for and/or registers for a race event. In this example, FIG. 4 illustrates an exemplary login interface 400 that may be displayed to the consumer 112 at his/her communication device 116, after the consumer 112 installs the fitness-pass application 118 thereto and registers with the fitness-pass engine 120. As shown, the interface 400 includes a button 402 to allow the consumer 112 to login to the fitness-pass application 118, and an event indication 404 of current events that satisfy various preferences previously provided by the consumer 112 (e.g., provided by the consumer at 314 in the method 300, etc.). In particular, the indication 404 states that there are 3 races this month in your area.

FIG. 5 illustrates an exemplary interface 500 that may be displayed to the consumer 112 at his/her communication device 116 when the consumer 112 signs in to the fitness-pass application 118 (broadly, when the consumer 112 is authenticated to the fitness-pass application 118), via the interface 400 of FIG. 4. Consistent with the event indication 404 of the interface 400, the interface 500 includes a detailed listing 502 of the three races that satisfy the consumer's current preferences. The interface 500 also includes a search button 504 to allow the consumer 112 to perform a specific search for other registered events, as desired (e.g., to provide other inputs to the fitness-pass application 118 and fitness-pass engine 120 for use in searching for other events (e.g., as at 314, 318, and 320 in the method 300, etc.), etc.).

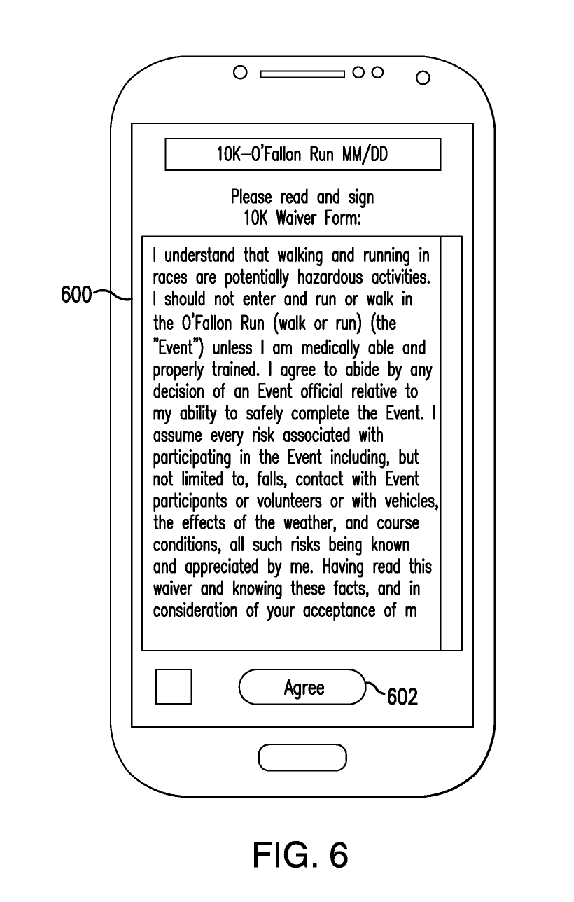

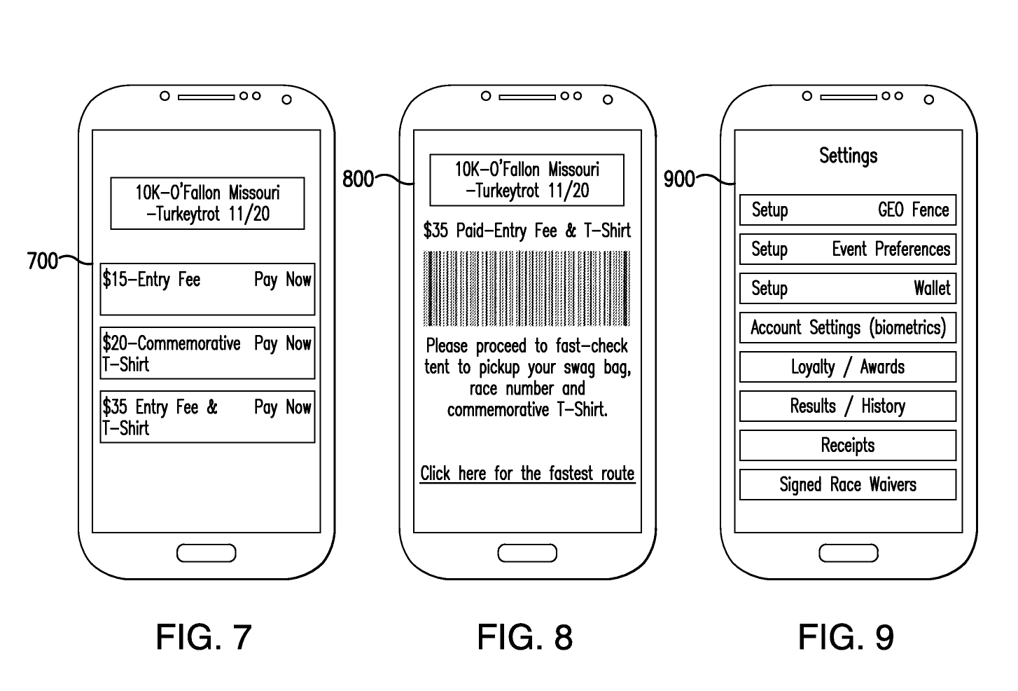

FIG. 6 illustrates an exemplary waiver interface 600 that may be displayed to the consumer 112 at his/her communication device 116 upon selection of the 10 k race in the interface 500, for example (e.g., upon receipt of the selection of the 10 k race by the consumer 112 at 326 in the method 300, etc.). The interface 600 includes a liability waiver provided by the organizer of the 10 k race, for example, for the consumer 112 to review and acknowledge in order to register for and participate in the 10 k race (e.g., via the agree button 602, etc.). In turn, FIG. 7 illustrates an exemplary payment interface 700 that may be displayed to the consumer 112 at his/her communication device 116, upon acknowledgement of the liability waiver by the consumer 112 at the interface 600, for use in facilitating a payment account transaction for registering the consumer 112 for the 10 k race (e.g., as facilitated at 328 in the method 300, etc.). In particular, at the interface 700, the consumer 112 has options to pay an entry fee for the 10 k race, purchase a commemorative t-shirt for the 10 k race, and both pay the entry fee and purchase the commemorative t-shirt.

FIG. 8 then illustrates an exemplary confirmation interface 800 that may be displayed to the consumer 112 at his/her communication device 116, upon selection by the consumer 112 to pay the entry fee for the 10 k race and purchase the commemorative t-shirt at the interface 700. The confirmation interface 800 includes an indication that the appropriate fee has been paid for the entry fee and the t-shirt, a barcode that may be subsequently used to identify the consumer 112 and/or the registration for the 10 k race, and a link with directions to assist the consumer 112 in finding the fast-check tent to pick up various items associated with the 10 k race.

Also in this example, FIG. 9 illustrates an exemplary settings interface 900 that may be displayed to the consumer 112 at his/her communication device 116, when the consumer 112 signs in to the fitness-pass application 118, via the interface 400 of FIG. 4. As shown, the settings interface 900 provides multiple options for the consumer 112 to specify particular parameters for the fitness-pass application 118 associated with, for example, event selection, account authentication, payment account credentials, loyalty/award accounts, prior event history, prior event receipts, etc. In connection therewith, the consumer 112 may select one of the options and provide desired input(s) to the fitness-pass application 118 to add, update, change, etc. data associated with the selected option. For example, the consumer 112 may select the “Setup Event Preferences” option and specify notifications to be displayed at interfaces 400 and 500 for races within 50 miles of the consumer's home address (thereby resulting in the indication 404, at interface 400, stating that there are 3 races this month in your area, and the detailed listing 502, at interface 500, of the three races).

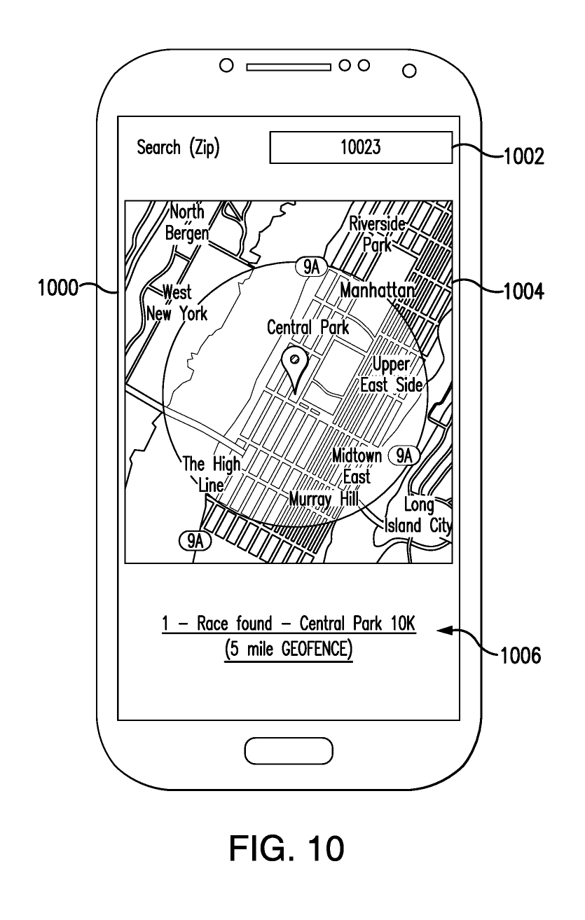

And, FIG. 10 illustrates an exemplary search interface 1000 that may be displayed to the consumer 112 at his/her communication device 116, when the consumer 112 selects the search button 504 at the interface 500 of FIG. 5. In the illustrated example, the interface 1000 includes a text box 1002 to allow the consumer 112 to search for registered events (e.g., for events registered to the fitness-pass engine 120, etc.) based on zip code, as well as a map 1004 and listing 1006 identifying results of the search. While the search interface 1000 is illustrated in FIG. 10 as facilitating a search based on zip code, it should be appreciated that the search interface 1000 (or other search interfaces) may facilitate similar searches based on other criteria in other embodiments (e.g., based on city, county, state, current consumer location, etc.).

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) generating a fitness-pass profile for a consumer, the fitness-pass profile associated with a fitness-pass application; (b) associating a payment credential with the fitness-pass profile, the payment credential indicative of a payment account of the consumer; (c) in response to an input from the fitness-pass application, transmitting event content to the fitness-pass application based on the input, the event content associated with at least one fitness event; (d) in response to a selection of the at least one fitness event, facilitating a transaction for at least one fee associated with the at least one fitness event between a fitness event organizer associated with the at least one fitness event and the payment account of the consumer; (e) transmitting a confirmation of the transaction to the fitness event organizer, whereby the fitness event organizer is able to permit the consumer access to the at least one the fitness event; (f) soliciting a waiver of liability associated with the at least one fitness event, prior to facilitating the transaction; (g) transmitting a confirmation of the transaction to the fitness-pass application, the confirmation including a code known to the fitness event organizer; and (h) receiving an input from the fitness-pass application indicative of a presence of the consumer at the at least one fitness event consistent with the access to the at least one fitness event permitted by the fitness event organizer.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “connected to,” “coupled to,” or “in communication with” another feature, it may be directly on, connected or coupled to, or in communication with the other feature, or intervening features may be present. In contrast, when a feature is referred to as being “directly on,” “directly connected to,” “directly coupled to,” or “directly in communication with” another feature, there may be no intervening features present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating payment account transactions in connection with registration of consumers to participate in fitness events, the method comprising:
generating, at a fitness-pass engine, a fitness-pass profile for a consumer, the fitness-pass profile associated with a fitness-pass application;
associating a payment credential with the fitness-pass profile, the payment credential indicative of a payment account of the consumer;
in response to an input from the fitness-pass application, transmitting, by the fitness-pass engine, event content to the fitness-pass application based on the input, the event content associated with at least one fitness event;
in response to a selection of the at least one fitness event, facilitating a payment account transaction for at least one fee associated with the at least one fitness event between a fitness event organizer associated with the at least one fitness event and the payment account of the consumer; and
transmitting, by the fitness-pass engine, a confirmation of the payment account transaction to the fitness event organizer, whereby the fitness event organizer is able to permit the consumer access to the at least one the fitness event.

2. The computer-implemented method of claim 1, wherein associating a payment credential with the fitness-pass profile includes provisioning a payment token to the fitness-pass application, the payment token associated with the payment account of the consumer.

3. The computer-implemented method of claim 1, further comprising receiving the input from the fitness-pass application, the input including location data associated with a communication device in which the fitness-pass application is active; and
identifying the at least one fitness event based on the location data.

4. The computer-implemented method of claim 1, further comprising receiving the input from the fitness-pass application, the input including search criteria from the consumer; and
identifying the at least one fitness event based on the search criteria.

5. The computer-implemented method of claim 1, further comprising soliciting, by the fitness-pass engine, a waiver of liability associated with the at least one fitness event, prior to facilitating the payment account transaction.

6. The computer-implemented method of claim 5, further comprising transmitting, by the fitness-pass engine, a confirmation of the payment account transaction to the fitness-pass application, the confirmation including a code known to the fitness event organizer.

7. The computer-implemented method of claim 1, further comprising:
soliciting, by the fitness-pass engine, the event content for the at least one fitness event from the fitness event organizer in connection with registering the at least one fitness event to the computing device; and
storing the event content in a data structure in association with the at least one fitness event.

8. The computer-implemented method of claim 7, further comprising, in response to the input from the fitness-pass application, retrieving the event content from the data structure prior to transmitting the event content to the fitness-pass application.

9. A system for use in facilitating payment account transactions in connection with fitness events, the system comprising:
at least one memory comprising a plurality of fitness events and a fitness-pass profile for a consumer; and
a fitness-pass engine coupled to the memory and configured to:
receive an input from a fitness-pass application, the fitness-pass application associated with the fitness-pass profile;
identify, in the at least one memory, one of the plurality of fitness events based on the input;
return the identified one of the plurality of fitness events to the fitness-pass application; and
in response to a selection of the identified one of the plurality of fitness events, facilitate a payment account transaction for fees associated with the selection.

10. The system of claim 9, wherein the fitness-pass engine is configured, in connection with facilitating the payment account transaction for fees, to retrieve and/or receive a payment credential from the fitness-pass application for a payment account associated with the consumer to thereby facilitate the payment account transaction for the fees.

11. The system of claim 10, wherein the fitness-pass engine is further configured to transmit a confirmation of the payment account transaction to the fitness-pass application, the confirmation including a code known to a fitness event organizer associated with the identified one of the plurality of fitness events.

12. The system of claim 11, wherein the fitness-pass engine is further configured to transmit a confirmation of the payment account transaction to the fitness event organizer, whereby the fitness event organizer is able to permit the consumer access to the identified one of the plurality of fitness events.

13. The system of claim 9, wherein the input includes location data associated with a communication device in which the fitness-pass application is active.

14. The system of claim 9, wherein the input includes search criteria from a consumer associated with the fitness-pass profile.

15. The system of claim 9, wherein the fitness-pass engine is further configured to:
generate the fitness-pass profile for the consumer and store the fitness-pass profile in the at least one memory; and
solicit at least one event preference from the consumer and store the at least one event preference in the fitness-pass profile.

16. The system of claim 15, wherein the fitness-pass engine is further configured to:
identify, in the at least one memory, one of the plurality of fitness events based on the at least one event preference stored in the fitness-pass profile for the consumer; and
return the identified one of the plurality of fitness events to the fitness-pass application for display to the consumer.

17. The system of claim 9, wherein the fitness-pass engine is further configured, for each of the plurality of fitness events stored in the at least one memory, to solicit event content for the fitness event from a fitness event organizer associated with the fitness event to thereby register the fitness event with the fitness-pass engine; and
wherein the fitness-pass engine is configured, in connection with returning the identified one of the plurality of fitness events to the fitness-pass application, to retrieve event content for the identified one of the plurality of fitness events in the at least one memory and further return the retrieved event content to the fitness-pass application.

18. A non-transitory computer-readable storage media including executable instructions for use in facilitating payment account transactions in connection with registration of consumers to participate in fitness events, which, when executed by a processor, cause the processor to:
identify at least one fitness event in a data structure consistent with an input associated with a consumer;
return the identified at least one fitness event to a fitness-pass application for display at a communication device associated with the consumer and in which the fitness-pass application is active;
receive a selection from the fitness-pass application of the at least one fitness event;
in response to the selection, transmit event content to the fitness-pass application for the at least one fitness event;
facilitate a payment account transaction for at least one fee associated with the at least one fitness event between a fitness event organizer associated with the at least one fitness event and a payment account of the consumer;
transmit a confirmation of the payment account transaction to the fitness event organizer, whereby the fitness event organizer is able to permit the consumer access to the at least one fitness event; and
receive an input from the fitness-pass application indicative of a presence of the consumer at the at least one fitness event consistent with the access to the at least one fitness event permitted by the fitness event organizer.

19. The non-transitory computer-readable storage media of claim 18, wherein the executable instructions, when executed by the processor in connection with facilitating the payment account transaction for the at least one fee, cause the processor to retrieve and/or receive a payment credential for the payment account from the fitness-pass application to facilitate the payment account transaction for the at least one fee.

20. The non-transitory computer-readable storage media of claim 18, wherein the input associated with the consumer includes one or more of location data associated with the communication device in which the fitness-pass application is active, search criteria from the consumer, and an event preference for the consumer included in a fitness-pass profile of the consumer.
